(19) United States
(12) Patent Application Publication
(10) Pub. No.: US 2011/0031044 A1
(43) Pub. Date: Feb. 10, 2011

(54) ROBOTIC PLATFORM & METHODS FOR OVERCOMING OBSTACLES

(76) Inventor: Ehud Gal, Reut (IL)

Correspondence Address: Steven Carl Lessoff, Box 477, 925/3 Levi Yitzchak II, Kfar Chabad, 60840, IL

(21) Appl. No.: 12/844,884

(22) Filed: Jul. 28, 2010

Related U.S. Application Data
(60) Provisional application No. 61/231,031, filed on Aug. 4, 2009.

(51) Int. Cl. B62D 55/00

(52) U.S. Cl. 180/8.2

(57) ABSTRACT

A robotic platform is presented, having a tiltable operational assembly. The operational assembly incorporates imaging means, designation means and operational means in a synchronized manner thus simplifying the maneuvering of the robotic platform and the operation of its operational means by a remote operator. The operational assembly can be tilted backwards in order to shift the center of gravity of the robotic platform towards its rear to decrease pressure from the front end of the robotic platform to the ground. Alternatively, the operational assembly can be used as an arm which applies pressure over obstacles to raise its distal end from the ground while overcoming obstacles. Tilting the operational assembly also provides double-sided operation of the robotic platform without the need to perform maneuvers which flip the entire robotic platform.

This patent application claims the benefit of U.S. Provisional Patent Application No. 61/231,031 filed 4 Aug. 2009.

### FIELD AND BACKGROUND OF THE INVENTION

The art of robotics has increasingly developed throughout the years, and many solutions have been offered for remotely controlling a robotic platform with extended operational and maneuvering capabilities.

The solutions offered by the art are usually customized to the requirements for which a robotic platform is designed.

One major challenge in the field of robotics is mobility, in other words, the ability to drive a robotic platform from one point to another. This allegedly simple challenge comprises a few challenging tasks, which can be generally categorized as follows: (i) incorporating a driving mechanism to provide propelling power to the robotic platform, (ii) incorporating sensors and communication means to intuitively control the driving mechanism and (iii) incorporating mechanisms to overcome obstacles. Each of these tasks can be addressed by various solutions. The solutions are usually customized according to the requirements for which a robotic platform is designed. For instance, a requirement to control a platform from a remote location (with no direct line of site) usually dictates the need to incorporate imaging sensors in the platform and a wireless transceiver to transmit the information captured by the imaging sensors to a remote control station which presents the captured images to an operator and from which the operator can send command signals which are received by the robotic platform's transceiver and are processed. Another level of complexity is added to this task when the control over the platform is to be maintained during changing environmental conditions such as darkness, harsh weather, etc.

A common obstacle that a robotic platform may need to overcome is stairs. Various mechanisms and platforms have been offered by the art in order to climb and descend stairs.

Another major challenge in the field of robotics is synchronization, in other words, the ability to coordinate between different components integrated into a robotic platform in a manner which facilitates controlling the robotic platform by a remote operator. Many robotic platforms incorporate different factors, for example a military or police robot may include: (a) reconnaissance means which are used to report a local scene to a remote operator and also to orient the robotic platform relative to its surroundings for example for navigation (e.g., imaging sensors, acoustic sensors, etc.), (b) operational means which can be activated towards targets which are found in the robotic platform's surroundings (e.g., non lethal weapons such as pepper sprays and electric stunners, or lethal weapons such as guns and rifles), and (c) designation means, which are used to aim the operational means towards targets detected by the reconnaissance means (e.g., laser based designators, sights, etc.). Most robotic platforms offered by the prior art include dedicated mechanisms and interfaces in order to enable control over the operational means which are incorporated into the robotic platforms. This results in a high level of training and expertise which is required by the platform's operator in order to control both the maneuvering of the platform as well as its operational means under combat pressure. In addition, this requires quite bulky remote-control units which are not adequate for operational needs. Another level of complexity is added to this synchronization of the three factors described above when synchronization is to be maintained when the robotic platform is in motion or when some of the components described above need to be traversed or tilted towards targets in the surroundings of the robotic platform. This challenge will be addressed herein as the “Three Factor Dynamic Synchronization Challenge”.

Some typical publications that demonstrate the state of the art are:

U.S. Pat. No. 6,263,989 to Won depicts an articulated tracked vehicle that has a main section, which includes a main frame, and a forward section. The main frame has two sides and a front end, and includes a pair of parallel main tracks. Each main track includes a flexible continuous belt coupled to a corresponding side of the main frame. The forward section includes an elongated arm. One end of the arm is pivotally coupled to the main frame near the forward end of the main frame about a transverse axis that is generally perpendicular to the sides of the main frame. The arm has a length sufficiently long to allow the forward section to extend below the main section in at least some degrees of rotation of the arm, and a length shorter than the length of the main section. The center of mass of the main section is located forward of the rearmost point reached by the end of the arm in its pivoting about the transverse axis. The main section is contained within the volume defined by the main tracks and is symmetrical about a horizontal plane, thereby allowing inverted operation of the robot.

The patent described above includes an elongated arm pivotally coupled to the main frame. The elongated arm allows overturning the platform when it lands on its back side by performing a certain maneuver (the “Flipping Maneuver”) and in addition this mechanism is utilized for climbing stairs. The main drawbacks of such a mechanism and the Flipping Maneuver from an operational point of view are (i) the need to perform the Flipping Maneuver when the platform lands on its back side simply delays the platform's operation, (ii) the Flipping Maneuver mechanism is vulnerable during deployment due to the elongated arm which extends out of the secured main frame, (iii) the need to perform the Flipping Maneuver may jeopardize the operation of the platform when it lands near obstacles which might prevent performing the Flipping Maneuver and (iv) the elongated arms associated with the platform increase the overall volume of the platform and therefore decrease its mobility in condensed environments such as tunnels, earthquake wrecks, buildings, etc.

US patent application publication 20040168837 to Michaud depicts a modular robotic platform having four legs mounted to a body. Each of the legs is mounted to the body via a steering assembly so as to pivot in a first plane relatively to the body. Each leg includes an endless track assembly having a first wheel, a drive system for driving the first wheel, a second wheel, an endless track for rotatably coupling the second wheel to the first wheel, and a track tensioning assembly for pivoting the leg in a second plane perpendicular to the first plane. Each leg includes a locomotion controller and a local environment recognition module. Synchronization of the legs is achieved by a central controller, which gathers data information from each leg through a synchronization bus. A coordination bus allows the exchange of data between different modules of the robotic platform, including the legs, the central control system and other systems or modules such as an energizing system, a pitch gauge system, etc. A communication protocol is used allowing each module to know which data messages carried on the communication buses are intended for it.

The publication described by Michaud discloses a driving mechanism to extend maneuverability and to enable climbing and descending an obstacle such as stairs. Michaud does not seem to provide a solution for turning the platform over when it inadvertently lands on its back side during its operation. In addition, the drive mechanism having four independent legs each with two degrees of freedom is both complex and costly to manufacture. Furthermore, control of such a complex drive mechanism also requires a complex controlling mechanism and protocols.

International application PCT/IL/0800585 to Gal (Gal '585) teaches a robotic mobile platform vehicle that can be thrown into hostile or hazardous environments for gathering information and transmitting that information to a remotely located control station. One of the key features of the invention is that at least four imaging assemblies are mounted on the robotic platform and that the system has the processing ability to stitch the views taken by the four imaging devices together into an Omni-directional image, allowing simultaneous viewing of a 360 degree field of view surrounding the mobile platform. Another feature is that the system comprises a touch screen GUI and the robotic mobile platform is equipped with processing means and appropriate software. This combination enables the user to steer the robotic platform simply by touching an object in one of the displayed images that he wants to investigate. The robotic platform can then either point its sensors towards that object or, if so instructed, compute the direction to the object and travel to it without any further input from the user.

The application above focuses on addressing task number (ii) (as described above) by providing intuitive remote control means to the platform's operator. In addition, the bilateral capability of the robotic platform may enable it to overcome certain kinds of obstacles by the fact that an inadvertent turnover of the platform does not interrupt its operation. Hence, the platform may basically roll down over obstacles. However, the platform of Gal ‘585 lacks the ability to actively climb obstacles such as stairs. In addition, the bilateral capability is based on the symmetry of the platform and its sensors. This symmetry takes its toll, by directing the sensors horizontally instead of tilting the sensors towards the desired region of interest which is usually elevated relatively to this compact platform. Furthermore, vertical symmetry requires that the sensors be located on the mid line of the platform. Thus the platform can not raise its head (sensors) to see over obstacles.

U.S. published patent application no. 2008/0277172 to Ben-Tzvi et al. (BenTzvi '172) describes a bilateral tracked platform with a rotating articulated manipulator arm that serves both for locomotion and for manipulation. The manipulator arm BenTzvi '172 is designed as a manipulative arm for maneuverability and for manipulation, BenTzvi '172 does not foresee use of a movable link for non-manipulative tasks. Particularly, BenTzvi '172 does not suggest use of the manipulative arm for reconnaissance and orientation of the robot (for example by placing the main sensors of the robot on the manipulative arm). In BenTzvi '172 the sensors of the platform are located on the main frame of the platform. Therefore, the symmetry of the main frame requires directing the sensors horizontally instead of tilting the sensors towards the desired region of interest which is usually elevated relatively to the low profile main frame. Furthermore, vertical symmetry requires that the sensors be located on the mid line of the platform. Thus the platform can not raise its head (sensors) to see over obstacles. This limits the view of the operator who must look at the operational scene from near the ground. Furthermore, the main sensors of BenTzvi '172 are not synchronized with the manipulator arm. For example, if the manipulator arm is acting upon some object behind or above the platform, a secondary set of sensors will need to be employed. The manipulator arm of BenTzvi '172 is a thin articulated member with complicated motion which is designed to extend completely out of the main frame of the platform when deployed. This makes the arm vulnerable to fouling if the platform is moved while the arm is deployed. Furthermore the complex motion of the arm makes it difficult to synchronize movement of the arm and locomotion of the entire platform. As a result the platform of BenTzvi '172 is not amenable to three-factor-synchronization of reconnaissance, designation and operational factors. Also the main frame of BenTzvi '172 is closed only on three sides, and therefore the manipulator arm is vulnerable to attack and fouling from the rear of the platform even when the arm is stowed. This is especially problematic if the platform is to move in reverse.

Most prior art robotic platforms, such as those described above, are able to perform with varying degrees of success only the specific tasks for which they were designed.

It would therefore be advantageous to provide a robotic platform with extended operational capabilities and with simplified control over the operational means incorporated into the robotic platform.

It would therefore be advantageous to provide a robotic platform with extended maneuvering capabilities which enables overcoming obstacles such as stairs.

It would therefore be advantageous to provide a Three Factor Dynamic Synchronization between the reconnaissance means, the operational means and the designation means incorporated into the robotic platform.

It would therefore be advantageous to provide a robotic platform capable of operating on both sides on which it may land when deployed, without the need to perform a flipping maneuver of the entire platform.

It would therefore be advantageous to provide a robotic platform capable of directing its reconnaissance means, its operational means and its designation means both horizontally and vertically towards targets in the surroundings of the platform regardless to the side on which the platform had landed after its deployment.

### SUMMARY OF THE INVENTION

Various embodiments are possible for a bilateral robotic capable of overcoming obstacles and various methods for operating a robotic platform and overcoming obstacles are possible.

A robotic platform may have a main frame and include a drive mechanism configured for propelling the robotic platform. The robotic platform may be capable of functioning bilaterally (either right side up or upside down). The robotic platform may also include an operational assembly configured for adjustably tilting with respect to the main frame and a sensor may be mounted to the operational assembly. The sensor may be configured for supplying a view with an operator may orient the robotic platform. The operational assembly may be configured for raising the sensor above the main frame of the robotic platform both in a right side up and in an upside configuration.

In an embodiment of a robotic platform the tilting of the operational assembly may be to a non-zero angle with respect to the main frame when the robotic platform is in a first vertical orientation. The operational assembly may be configured for reversing the tilt to an angle opposite to non-zero angle with respect to the main frame when the robotic is overturned (inverted from the first vertical orientation).

In an embodiment of a robotic platform the non-zero angle of the operational assembly with respect to the main frame when the robotic platform is in the operational mode may be an angle between 10 and 60 degrees.

An embodiment of a robotic platform may also include an image analysis algorithm and the robotic platform may be configured to adjust the non zero angle between the operational assembly and the main frame based on an output of the image analysis algorithm.

In an embodiment of a robotic platform the tilting of the operational assembly when in operation mode to non-zero angle may raise the sensor above the main frame.

In an embodiment of a robotic platform the operational assembly may be configured such that the majority of the volume of the operational assembly is located within the main frame of the robotic platform when the operational assembly is tilted at the non-zero angle of the operational mode.

In an embodiment of a robotic platform the operational assembly may be configured to fit entirely within the main frame when the robotic platform is in a protected mode.

In an embodiment of a robotic platform the operation assembly may be configured such that the majority of the volume of the operation assembly is surrounded on four sides by the main frame when the robotic platform is in the operational mode.

An embodiment of a robotic platform may also include a window in a front panel of the main frame. The window may be configured such that when the robotic platform is in the protected mode the sensor is directed through the window.

In an embodiment of a robotic platform the tilting of the operational assembly with respect to the main frame may be to an angle of zero degrees when the robotic platform is in the protected mode.

In an embodiment of a robotic platform one end of the main frame may be joined by a revolute joint.

In an embodiment of a robotic platform the operational assembly may be configured for facilitating traversing an obstacle by the robotic platform.

In an embodiment of a robotic platform the operational assembly may facilitate overcoming and obstacle by shifting the center of gravity of the robotic platform away from the obstacle. The shifting of the center of gravity may assist in raising of an near end of the robotic platform (the near end being the end that is near the obstacle) over the obstacle.

In an embodiment of a robotic platform the operational assembly may facilitate overcoming and obstacle by shifting the center of gravity of the robotic platform in a direction of desired motion and over the obstacle. This may assist in raising a far end of the robotic platform (the far end being the end which is far from the obstacle).

In an embodiment of a robotic platform the operational assembly may facilitate overcoming and obstacle a power supply of the robotic platform may be mounted to the operational assembly. Mounting the power supply to the operational assembly may cause moving of the power supply when the operational assembly changes angel and because the power supply is heavy, this may cause a large change in the location of the center of mass of the robotic platform.

In an embodiment of a robotic platform the operational assembly may facilitate overcoming and obstacle by raising of the sensor above the main frame may be done during traveling of the robotic platform by the above mentioned propelling.

An embodiment of a robotic platform may further include a designator, and wherein the designator may be mounted to the operational assembly.

In an embodiment of a robotic platform the designator may include a laser, an overlay target mark inscribed to the sensor, an electronically produced target mark or a sight.

In an embodiment of a robotic platform the designator may be synchronized with the sensor.

In an embodiment of a robotic platform the designator may be directed along an axis of the operational assembly.

In an embodiment of a robotic platform the sensor may be directed along an axis of said operational assembly.

In an embodiment of a robotic platform the operational assembly may be configured to raise said sensor over an obstacle.

In an embodiment of a robotic platform the operational assembly may be configured to pivot.

An embodiment of a robotic platform may also include a weapon, and the weapon may be mounted to the operational assembly.

In an embodiment of a robotic platform the weapon may be synchronized with the sensor.

In an embodiment of a robotic platform the weapon may be directed along an axis of the operational assembly.

In an embodiment of a robotic platform the weapon may include a barrel based weapon, an electric shocking based weapon, a spray based weapon, a directional acoustic based weapon or a dazzling based weapon.

In an embodiment of a robotic platform the sensor may includes an imaging sensor, a light source, a microphone, a light detector, a noise detector, a volume detector, a nuclear detector, a biological detector, a chemical (NBC) detector or a range detector.

In an embodiment of a robotic platform the sensor may be configured to provide stereoscopic vision capabilities.

In an embodiment of a robotic platform the central assembly may be divided into compartments.

In an embodiment of a robotic platform the propulsion mechanism may include wheels, tracks, sliding fins or a sub propelling mechanism.

In an embodiment of a robotic platform the operational assembly may be articulated.

In an embodiment of a robotic platform the operational assembly may be at least partially covered by a solar panel.

In an embodiment of a robotic platform a control signal may be reversed when the robotic platform is inverted.

In an embodiment of a robotic platform an operator display image may flip 180 degrees when the robotic platform is inverted.

An embodiment of a method of overcoming an obstacle with a robotic platform may include approaching the obstacle, and shifting the center of gravity of the robotic platform away from the obstacle in order to facilitate raising a near end of the robotic platform (the near end being the end that is near the obstacle).

An embodiment of a method of overcoming an obstacle with a robotic platform may include raising a near end (the near end being the end that is near the obstacle) of the robotic platform over the obstacle, and shifting the center of gravity of the robotic platform in the direction of travel thereby facilitating raising of a far end of the robotic platform (the far end being the end that is far from the obstacle).

### BRIEF DESCRIPTION OF THE DRAWINGS

FIG. 1 schematically shows a perspective view of the basic components of a preferred embodiment of the robotic platform in an operational mode;

FIGS. 2A, 2B, 2C, 2D, and 2E schematically show perspective views of various positions of the operational assembly relative to the main frame wherein FIG. 2A shows the protected mode; FIG. 2B shows a heads up operational mode; FIG. 2C shows a straight up mode; FIG. 2D shows a backward tilted mode, and FIG. 2E shows a leverage mode;

FIGS. 3A, 3B, 3C, 3D, 3E and 3F schematically show a side projection of a method for climbing steps by adjusting the center of gravity; FIG. 3A shows the positioning of the robotic platform with the front end towards the first step; FIG. 3B shows moving the center of gravity backwards away from the steps to raise the front end to permit climbing over the first step; FIG. 3C shows the robotic platform being propelled over the first step to the second step; FIG. 3E shows climbing over the second step; FIG. 3E shows sustained climbing up the steps;

FIGS. 4A, 4B, 4C, 4D, 4E and 4F schematically show a side projection of another method for overcoming a step by a robotic platform; FIG. 4A shows the positioning of the robotic platform with the rear end towards the step; FIG. 4B shows levering the rear of the platform upward; FIG. 4C shows use of reverse traction to propel the rear of the platform up the step; FIG. 4D shows shifting of the center of gravity and levering to overcome the edge of the step; FIG. 4E shows use of reverse traction to pull the platform up the step, and FIG. 4F shows raising the front of the platform over the step;

FIGS. 5A, 5B, 5C, 5D, 5E and 5F schematically show a perspective view of various modes of a preferred embodiment of a robotic platform having an articulated operational assembly; FIG. 5A shows a protected mode; FIG. 5B shows an operational mode; FIG. 5C shows a highly tilted exploring mode; FIG. 5D shows a low profile exploring mode; FIG. 5E shows a rear facing exploring mode; FIG. 5F shows a reconnaissance exploring mode;

FIG. 6 schematically describes a perspective view of some of the components which are incorporated into the operational assembly in a preferred embodiment of the present invention;

FIG. 7 is a flowchart illustrating a method to operate a bilateral platform after overturning;

FIG. 8 is a flowchart illustrating a first method to overcome an obstacle, and

FIG. 9 is a flowchart illustrating a second method to overcome an obstacle.

### DETAILED DESCRIPTION OF THE INVENTION

For a better understanding of the invention and to show how the same may be carried into effect, reference will now be made, purely by way of example, to the accompanying drawings. With specific reference to the drawings in detail, it is stressed that the particulars shown are by way of example and for purposes of illustrative discussion of preferred embodiments of the present invention only, and are presented for the purpose of providing what is believed to be the most useful and readily understood description of the principles and conceptual aspects of the invention. In this regard, no attempt is made to show structural details of the invention in more detail than is necessary for a fundamental understanding of the invention. From the description taken together with the drawings it will be apparent to those skilled in the art how the several forms of the invention may be embodied in practice.

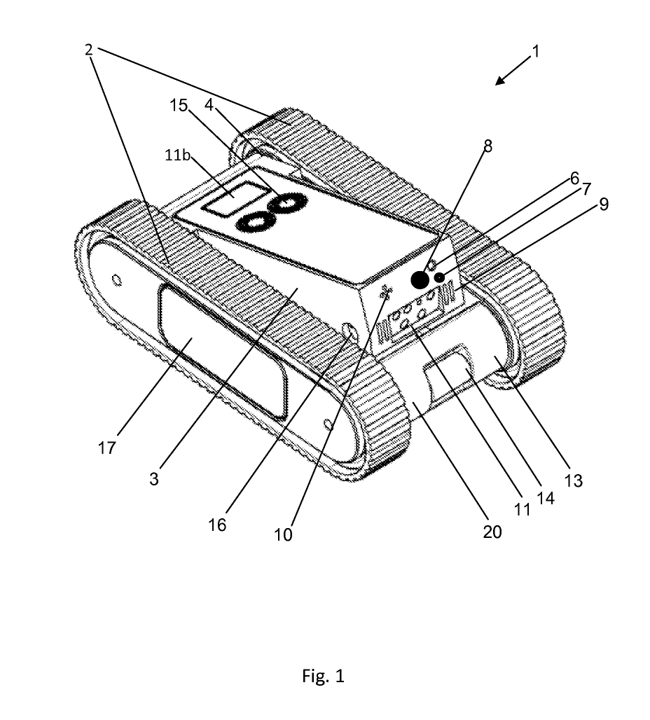

FIG. 1 schematically shows a perspective view of the basic components of a preferred embodiment of the robotic platform in an operational mode.

In a preferred embodiment, a robotic platform 1 includes a main frame 2, which is harnessed to an operational assembly 3. A revolute joint 4 joins both sides of main frame 2 to operational assembly 3, in the embodiment of FIG. 1, revolute joint 4 extends from one side of main frame 2 to the other side. In the embodiment of robotic platform 1, revolute joint 4 is part of main frame 2 and protects operational assembly 3 from attacks from behind. Alternatively, two revolute joints can be incorporated, one from each side of main frame 2. A driving mechanism (not shown) is coupled to main frame 2 and is used to propel robotic platform 1 by supplying driving force to dual tracks mounted on the two sides of main frame 2. The driving mechanism is also coupled to the revolute joint 4 and thus provides control over the inclination (tilt) of operational assembly 3 with respect to main frame 2.

In the preferred embodiment of FIG. 1, operational assembly 3 includes three factors: a reconnaissance sensor, which is a high resolution video camera 6; a target designator, which is a synchronized laser pointer 7; and an operational device, which is a gun 8. The three factors function in a synchronized manner All three factors are installed inside of operational assembly 3. Because all three factors are packed in a synchronized manner inside of operational assembly 3, a remote operator can easily direct all three factors simultaneously towards a target simply by rotating the robotic platform. From an operational point of view, the remote operator sees a video image which already includes a laser mark around the center of the image towards which the gun 8 is aimed. The remote operator can point the laser mark towards a target of his choice simply by sending control signals to propel robotic platform 1, thus, moving the video image with its laser mark until the laser mark is placed on the required target. When the laser mark is on the required target, the remote operator activates the operational device towards the target by pressing a single button. This Three Factor Dynamic Synchronization facilitates the control over robotic platform 1 and its operational means. In other words, the same driving mechanisms which are used to propel the platform and the same reconnaissance sensors which are used to orient the platform are also used to aim the operational device towards targets from a remote control station. Thus, the remote control station does not require separate dedicated interfaces to aim the operational device and robotic platform 1 does not require dedicated mechanisms to aim the operational means towards targets.

In FIG. 1 robotic platform 1 is shown in an operational configuration. Operational assembly 3 is tilted at an angle of 30 degrees. In operational mode, high resolution video camera 6, laser pointer 7, gun 8 and pepper spray 10, which are organized in a synchronized manner within operational assembly 3 are exposed and aimed along the axis of operational assembly 3 in a predefined angle of about 30 degrees relative to main frame 2. This default 30 degrees angle focuses high resolution video camera 6, laser pointer 7, gun 8 and pepper spray 10 towards the average center of an operational scene in order to capture targets in an operational scene. The 30 degree angle also allows high resolution video camera 6 to capture enough the ground ahead of robotic platform 1; the resulting image may therefore serve for a remote operator to orient robotic assembly 1 while the robotic platform is traveling. The predetermined angle (30 degrees with the vertical and aligned with the horizontal axis of robotic platform) makes it easy for an operator to get a clear situational awareness. Furthermore, the 30 degree angle of operational assembly 3 during operational mode is enough to raise high resolution video camera 6 above main frame 2 for a good view of the operational scene but nevertheless leaves most of operational assembly 2 protected inside of main frame 2.

In an alternative embodiment, the operational means may also include a loudspeaker. A loudspeaker can be used for remote negotiations with hostile forces or transfer of commands or for giving warning or directions to forces in the field.

Robotic platform 1 is bilateral. This means that the platform functions with either side up. Thus, it doesn't matter on which side robotic platform 1 lands during deployment and similarly if robotic platform 1 overturns while driving over an obstacle, robotic platform 1 continues to function in the inverted orientation. In robotic platform 1 the Three Factor Dynamic Synchronization is maintained regardless to the side on which the platform operates. Specifically, in the case of the embodiment of robotic platform 1, when robotic platform 1 is overturned (to the opposite vertical orientation from that illustrated in FIG. 1), operational assembly 3 is reversed from a 30 degree angle with main frame 2 (shown in FIG. 1) to a −30 degree angle with main frame 2 (for the inverted robotic platform 1 tilting operational assembly 3 to −30 degrees with main frame 2 results in a 30 degree upward tilt of operational assembly). This maneuver can be performed automatically using an orientation sensor which enables automatic upwards tilting of operational assembly 3, a 180-degree flip of the image displayed on the operator's control unit and a trigger to invert automatically the maneuvering signals sent by the operator. In such a manner, the operator is indifferent to the side on which the robotic platform 1 lands or operates. Thus after overturning, robotic platform 1 has complete functionality and synchronization as if had not overturned. This enables double-sided operation without ever needing to physically re-invert robotic platform 1 and without the operator needed to learn complex maneuvers or alternative procedures in case of overturning.

The same principles of continuous synchronization between the components integrated inside operational assembly 3 as described above can also apply to other components such as illumination LEDs 9 which illuminate the field of view of high resolution video camera 6 in a wavelength suitable to the imaging sensors.

A pepper spray 10 is integrated into operational assembly 3 in order to provide a non lethal weapon against targets. The aiming and the activation of pepper spray 10 is according to the Three Factor Dynamic Synchronization principles described above mutatis mutandis.

In robotic platform 1, a first control panel 11a is provided on the front of operational assembly 3 and a second control panel 11b on top of operational assembly 3 to turn robotic platform 1 on or off, to switch between operational modes and to provide indications of the status of robotic platform 1.

A front panel 20 of main frame 2 includes an additional set of sensors and a cover 14 to protect the additional sensors. When it is desired to used the additional sensors, cover 14 is opened to expose the additional sensors as explained below. It should be emphasized that main frame 2 is built as a closed rectangle made of the two tracked side members, front panel 20 and revolute joint 4. The closed shape gives main frame 2 strength and stiffness and protects operational assembly 3 and its delicate electronic components from four sides when operational assembly 2 is at a low angle (as illustrated in FIG. 1).

Operational assembly 3 includes a cooling mechanism which uses integrated ventilators 15 and ventilation holes 16 in order to disperse the heat generated by the components inside operational assembly 3.

Energy is supplied to robotic platform 1 by lithium ion batteries which are stacked at the sides of main frame 2, the batteries can be easily exchanged using openings 17 on each side of main frame 2.

It is worth emphasizing that in the operational mode robotic platform 1 has a low profile for travel in hostile territory. Nevertheless, the main sensor (high resolution video camera 6) is held above main frame 2 (also above the top of the traction mechanism, which is the tracks of main frame 2). This configuration can be achieved no matter which side of robotic platform is facing downward (to the ground). Thus, without wasteful replication of the main sensor, robotic platform 1 is capable bilaterally (with either side up) of heads up traveling with main sensors above the body of robotic platform 1 in a standard low profile operating configuration, even in hostile territory.

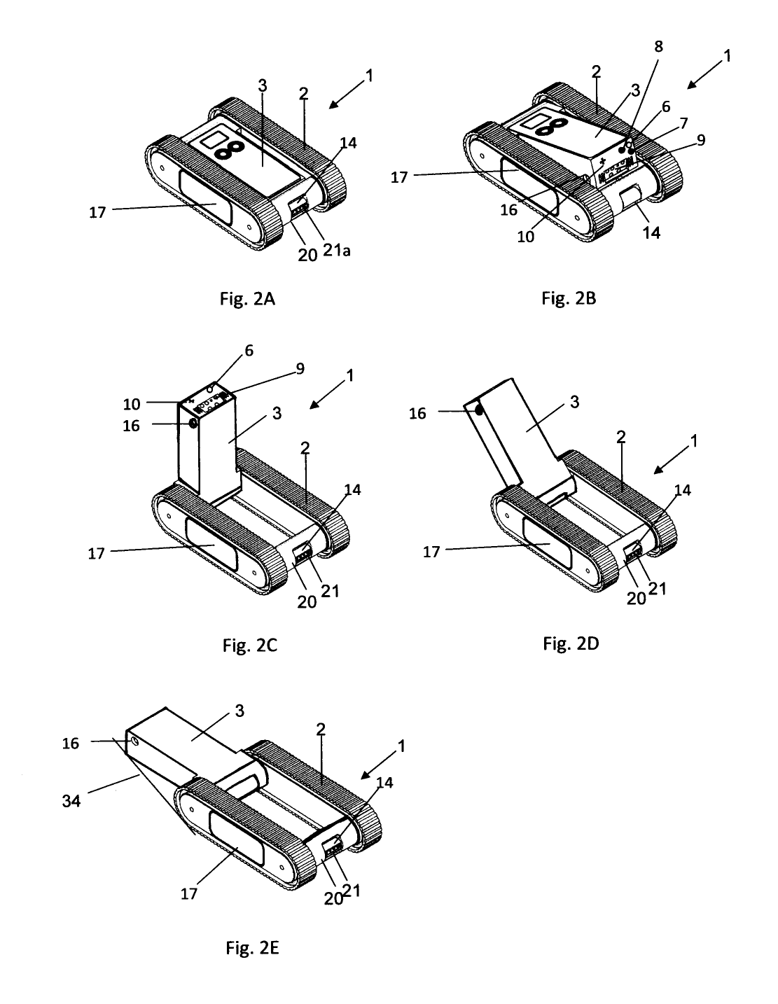

FIGS. 2A, 2B, 2C, 2D and 2E schematically show a perspective view of different positions of operational assembly 3 relative to main frame 2. FIG. 2A depicts robotic platform 1 in a “Protected Mode” in which operational assembly 3 lies protected from all four sides within main frame 2. Front panel 20 includes auxiliary sensors 21a which include various detectors (for example, a video camera, a microphone, an ultrasound imager, a volume detector, a range detector, an infrared detector, a thermometer, a Geiger counter) which are located in front of the operational assembly 3. When cover 14 is opened, auxiliary sensors 21a are exposed to provide alternative means of situational awareness and to operate as triggers to automatically switch robotic platform 1 from Protected Mode to Operational Mode, according to predefined criteria as further detailed below. Alternatively, front cover may also include a window (the window may have a removable opaque cover, a transparent cover or may be uncovered) through which main sensor 6 is directed during Protected Mode. The window allows main sensor 6 to function during protected mode. Robotic platform 1 is capable of self propulsion and traveling in Protected Mode using auxiliary sensors 21a for orientation (or alternatively using main sensor 6 through the window). When in Protected Mode robotic platform 1 has an exceedingly low profile and operation assembly 3 is protected from attack, collision, and entanglement with obstacles.

FIG. 2B depicts an operational mode of robotic platform 1. In operational mode, high resolution video camera 6, laser pointer 7, gun 8 and pepper spray 10, which are organized in a synchronized manner within operational assembly 3 are exposed and aimed along the axis of operational assembly 3 in a predefined angle of about 30 degrees relative to the main frame. This default 30 degrees angle focuses high resolution video camera 6, laser pointer 7, gun 8 and pepper spray 10 towards the average center of an operational scene in order to capture targets in an operational scene by the imaging sensors and in order to minimize the maneuvering commands required to point all three factors described above towards targets. This angle also provides sufficient view of the ground in order to drive the robotic platform from remote by the remote control unit (“Operational Mode”). The tilt of operational assembly 3 also raises high resolution video camera 6 to slightly above main frame 2, allowing improved view in uneven terrain. In alternative embodiments, the angle of tilt of operational assembly 3 during operational mode may range between 10 and 60 degrees. The tilting angle can be adjusted automatically by an image analysis algorithm, which for example locates one or more targets in the operational scene and adjusts the angle between operational assembly 3 and main frame 2 to maintain operational assembly 2 aimed at the targets as robotic platform 1 approaches the targets. The preferred mode of propulsion and traveling of robotic platform 1 is operational mode because in this mode main sensor 6 is in the optimal position (above main frame 2) and at the optimal angle (slightly upward tilt) for maximum situational awareness. If robotic platform 1 overturns, operation mode is regained in the new vertical orientation (without having to perform a flipping maneuver to return robotic platform 1 back into the original vertical orientation) by reversing the tilt of operational assembly 3 to an angle of −30 degrees with respect to main frame 2. In an alternative embodiment operational assembly 3 may be adjustable to a finite set of angles. For example, in one embodiment, operational assembly may be adjustable to 30 degrees for right side up operation, 0 degrees for protected mode and −30 degrees for inverted operation only. In various alternative embodiments the operational angle may have a fixed absolute magnitude of between 10 and 45 degrees.

When high resolution video camera 6 is exposed, cover 14 is closed as shown in FIG. 2B and the auxiliary sensors 21a of FIG. 2A are protected and not seen.

In order to switch from a Protected Mode to an Operational Mode, the user sends a command signal from his remote control station. Alternatively, the robotic platform can switch automatically between operational modes upon the occurrences of predefined events.

FIG. 2C depicts another possible position of operational assembly 3. In this position, operational assembly 3 is tilted upwards such that it extends vertical to main frame 2. This position can be utilized to investigate a region of interest above robotic platform 1. Such a position can also be utilized in order to try to extend the capability of sensors, detectors antennas or other components whose readings may be sensitive to their position relatively to the ground. Such a position can also be momentary during a backwards tilt of operational assembly 3, which is performed as a maneuver to overcome obstacles (such as steps) as shall be further detailed below. When operational assembly 3 is aimed upwards, cover 14 is opened in order to complete the situational awareness of occurrences in front of the platform. A second set of auxiliary sensors located behind ventilation holes 16 are integrated along the sides of operational assembly 3 to provide a wider coverage of the operational scene.

FIG. 2D schematically depicts yet another possible position of operational assembly 3 relative to main frame 2. In FIG. 2D operational assembly 3 is tilted by about 120 degrees relatively to its position during Protected Mode (as shown in FIG. 2A). Tilting operational assembly 3 as in FIG. 2D alters the center of gravity of robotic platform 1 and can be utilized to perform maneuvers as further detailed below. It is to be emphasized that such a position may also cause the front of main frame 2 to be raised from the ground, depending on the differences between the center of gravity of operational assembly 3 to the center of gravity of main frame 2. In the position of FIG. 2D, cover 14 is also opened exposing the auxiliary sensors 21a to provide information on occurrences in front of the robotic platform 1.

FIG. 2E schematically depicts yet another possible position of operational assembly 3 relatively to main frame 2. In FIG. 2E, operational assembly 3 is tilted by more than 180 degrees relative to its position during protected Mode (as shown in FIG. 2A) until operational assembly 3 comes in contact with the ground 34a. When operational assembly 3 is in contact with ground 34a, additional torque on revolute joint 4 pressures the top of operational assembly 3 against the ground 34a and raises the front of main frame 2 causing additional pressure on the back of the main frame 2 as further detailed below.

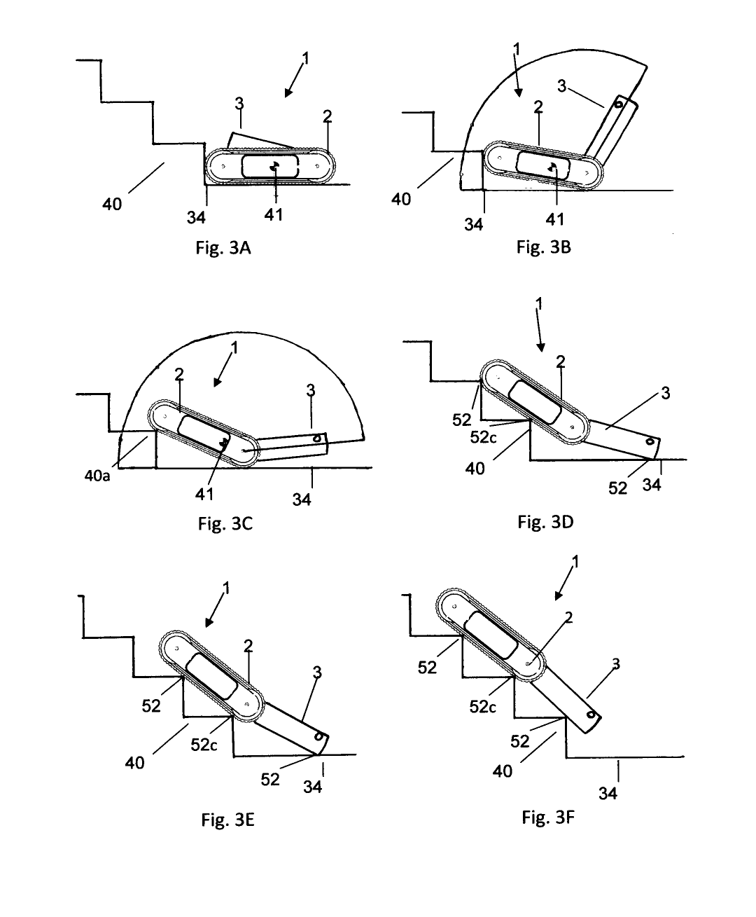

FIGS. 3A, 3B, 3C, 3D, 3E and 3F schematically show a side projection of a method for overcoming obstacles by the robotic platform. In the method of FIG. 3A-F, tilting of operational assembly 3 is used to facilitate overcoming an obstacle 40a.

FIG. 3A depicts the positioning of robotic platform 1 in front of the obstacle 40a which, in the example of FIG. 3A-F, is a stairway. The positioning of the robotic platform in front of the obstacle 40a can be either manually (i.e., robotic platform 1 is driven by maneuvering commands sent by an operator from a remote control unit) or automatically (i.e., the platform sensors recognize obstacles according to predefined criteria and activate the driving mechanism using a processing chip located inside of operational assembly 3 to drive the platform along the ground 34b to position the platform in front of the obstacle). The automation of this and of the other maneuvers described herein can be based on an imaging sensor and on algorithms which analyze the captured images (image processing/image understanding), on volume detectors, range detectors, ultrasounds or any other sensors, detectors or combinations thereof.

In this preferred embodiment, the center of gravity 41 is located about the center of the robotic platform 1.

FIG. 3B schematically illustrates the second step in the maneuvering method for overcoming an obstacle. In this step, operational assembly 3 is tilted backwards in order to shift center of gravity 41 from the center of main frame 2 to the rear of main frame 2 away from obstacle 40a. The further operational assembly 3 is tilted backwards, (increasing the angle between operational assembly 3 and main frame 2) the further center of gravity 41 shifts towards the rear of the robotic platform 1, as operational assembly 3 is tilted, the pressure between the front end of robotic platform 1 (the end that is near obstacle 40a) and ground 34b decreases; when operational assembly 3 is tilted backwards beyond a certain point, the front end of the robotic platform begins to “float” over ground 34b; and when operational assembly 3 is further tilted backwards the front end of the platform rises above ground 34b (this is a desirable side effect of this maneuver as illustrated in FIG. 3B). During the performance of this second step, the driving mechanism propels the platform forward using the tracks of main frame 2. The traction of the front of the tracks against the front face of obstacle 40a also pushes the front of robotic platform 1 upward.

It is to be emphasized that according to this second step, the front end of robotic platform 1 need not be literally raised from the ground by tilting of operational assembly 3. It is enough that tilting of operational assembly 3 decreases pressure between the front end of robotic platform 3 and ground 34b enough to enable slight propelling power applied by the front end of the tracks of robotic platform 1 to raise the front end of robotic platform 1 up obstacle 40a.

Another factor which is taken into consideration in the performance of this second step is the angular moment that results from deceleration of the tilting of operational assembly 3. This angular moment tends to lift the front of main frame 2. Therefore the faster the deceleration, the less operational assembly 3 needs to be tilted in order to decrease pressure from the ground by the front end of robotic platform 1 while the front end of the robotic platform 1 is being propelled over obstacle 40a. In other words, operational assembly 3 can be programmed to be tilted backwards and swiftly braked in order to decrease downward pressure on ground 34b for a few moments while the front end of robotic platform 1 is propelled over obstacle 40a. Furthermore, as operational assembly 3 is swiftly tilted back into Operational Mode, the moment of the acceleration of this forward tilting of operational assembly 3 also tends to lift the front of main frame 2 while robotic platform 1 continues the climbing process.

The choices between the different methods to perform this second step can be dictated by the nature of the obstacles to be overcome and by operational requirements. For example, choosing to overcome an obstacle not in an Operational Mode may enhance the traversability of the robotic platform during the climbing process but it compromises the readiness of the robotic platform for immediate action after the obstacle has been overcome, as compared to when the climbing process is performed in an Operational Mode.

When the second step is performed cover 14 is opened to expose auxiliary sensors 21a in order to enable remote observation in the forward direction.

FIG. 3C describes a third step in overcoming obstacle 40a. In the third step, operational assembly 3 is further tilted backwards and center of gravity 41 is further shifted backwards to raise the front end of robotic platform 1 higher and simultaneously, robotic platform 1 is further propelled forward until the front end of robotic platform 1 climbs over the first step of obstacle 40a. Because center of gravity 41 is so far back away from obstacle 40a is it relatively easy to lift the front of robotic platform 1 (the end near to obstacle 40a) over obstacle 40a.

FIG. 3D illustrates a fourth step in overcoming obstacle 40a. In the fourth step, operational assembly 3 is tilted further backwards until it comes in contact with ground 34b at a lower contact point 52a. When operational assembly 3 is in contact with ground 34b, robotic platform 1 acquires three contact points 52a, 52b and 52c which are utilized to balance the platform during its climb over obstacle 40a, a higher contact point 52b and a central contact point 52c are used as support anchors over which the tracks propel the platform further up the stairs.

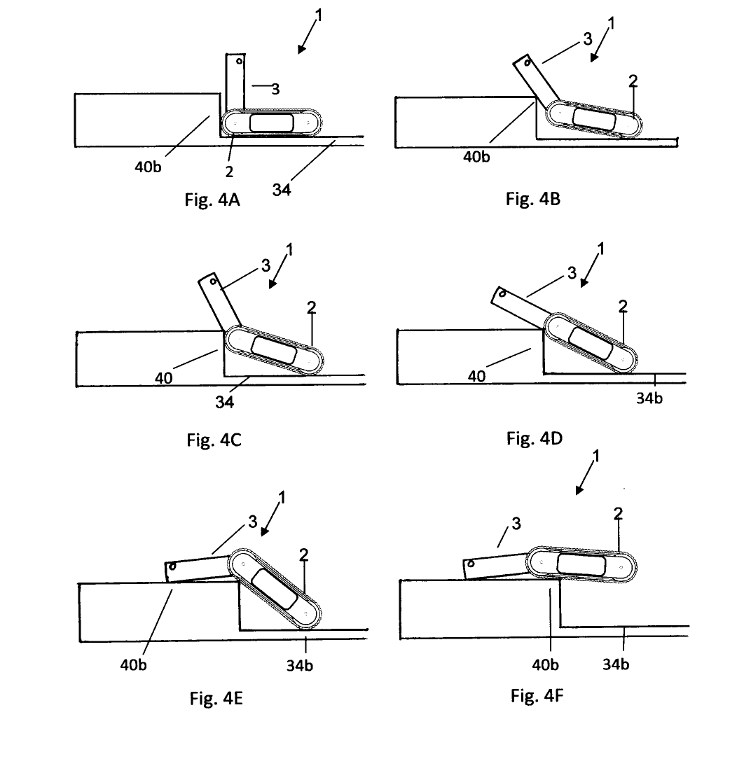

Contact point 52b between operational assembly 3 and ground 34b is utilized in order to adjust the angle of robotic platform 1 relative to obstacle 40a (i.e., operational assembly 3 is tilted further backwards in order to apply pressure on ground 34b, raising the distal end of main frame 2). These adjustments can be performed automatically using an algorithm and a set of sensors in order to tilt operational assembly 3 in accordance with the angle of main frame 2 relatively to ground 34b and in accordance with the pressure applied on different areas of robotic platform 1. Imaging sensors can also be utilized in order analyze the position of robotic platform 1 relative to obstacle 40a in order to activate the tilting mechanism to enhance the obstacle overcoming capabilities. Alternatively, the tilting mechanism of operational assembly 3 can be released while overcoming an obstacle 40b in order to utilize gravity to provide contact between the operational assembly and ground 34c as further described in regards to FIGS. 4A-F. Such mechanisms can also be utilized in order to maintain the front end of robotic platform 1 facing the front of obstacle 40a and thus avoiding drifting off of obstacle 40a during the climbing process. This can be achieved by differentiating the propelling power supplied to the right side tracks of main frame 2 in relation to the left side tracks of main frame 2.

FIG. 3E illustrates a fifth step in the maneuver overcoming obstacle 40a. In this step, operational assembly 3 is pressed against ground 34b at contact point 52a by tilting operational assembly 3. As a result, additional propelling power is applied on contact point 52b, which will therefore serve as a main anchor until the center of gravity of the robotic platform surpasses contact point 52b.

FIG. 3F illustrates a sixth step of maneuver to overcome obstacle 40a. In the sixth step, mechanism for tilting operational assembly 3 releases some of the torque on operational assembly 3 relative to main frame 2 such that there is less pressure on contact point 52a and operational assembly 3 is dragged up obstacle 40a by the tracks of main frame 2. While operational assembly 3 is dragged up obstacle 40a, modified pressure is applied by operational assembly 3 on obstacle 40a at contact point 52a. The torque on operational assembly 3 is constantly modified, thereby modifying the pressure on contact point 52a to increase the stability of robotic platform 1 during the climbing process.

In this preferred embodiment, robotic platform 1 continues ascending the stairs until both main frame 2 and the operational assembly 3 overcame all of the stairs. At this point, the tilting mechanism of operational assembly 3 is tilts operational assembly 3 back into its Operational Mode position and robotic platform 1 continues its mission.

FIGS. 4A, 4B, 4C, 4D, 4E and 4F schematically show a side projection of another method for overcoming obstacles by robotic platform 1. In the method of FIG. 4A-F, tilting of operational assembly 3 is used to facilitate overcoming an obstacle 40b.

FIG. 4A illustrates the first step of the second method for overcoming obstacles. In the first step, robotic platform 1 propels itself along the ground 34b until the distal end of main frame 2 is in front of obstacle 40b and operational assembly 3 is tilted into an upright position relatively to main frame 2.

FIG. 4B illustrates the second step of the second method for overcoming obstacles. In the second step, operational assembly 3 is tilted further backwards until it contacts obstacle 40b. After contact is made, the propelling mechanism puts torque onto operational assembly 3, thereby applying leveraging pressure to obstacle 40b. As a result of the leveraging pressure which is applied on obstacle 40b by operational assembly 3, the distal end of the main frame 2 is raised from ground until only the front end of main frame 2 remains in contact with ground 34b. It should be emphasized that in FIG. 4B, operational assembly has raised main sensor 6 (located on the front of operational assembly 3 and not visible due to the side perspective) over obstacle 40b. Due to the location of sensors on operational assembly 3, the operator can already see over obstacle 40b before the body of robotic platform starts to climb. This provides the operator with information on possible threats during the difficult climbing maneuver. Furthermore, gun 8 or pepper spray 10 are deployed and can be used against a target standing on top of obstacle 40b before overcoming obstacle 40b.

The front end of the tracks of main frame 2 propel the robotic platform in 1 in reverse (towards obstacle 40b).

FIG. 4C illustrates the third step of the second method for overcoming obstacles. During the third step, the front end of main frame 2 continues to propel robotic platform 1 in reverse until the distal end of main frame 2 comes in contact with the edge of obstacle 40b.

FIG. 4D illustrates the fourth step of the second method for overcoming obstacles. In the fourth step, operational assembly 3 is tilted further backwards in order to shift the center of gravity of robotic platform 3 higher and to improve the angle of attack at which main frame 2 contacts obstacle 40b. The tracks on the front end of main frame 2 continue to propel robotic platform 1 towards obstacle 40b.

FIG. 4E illustrates the fifth step of the second method for overcoming obstacles. In the fifth step, operational assembly 3 is tilted further backwards until its edge contacts the top of obstacle 40b in order to shift the center of gravity of robotic platform 1 higher. The tracks on the front end of main frame 2 push the distal end of main frame 2 over the edge of obstacle 40b. The edge of obstacle 40b is now used as a support anchor over which the distal end of main frame 2 propels the platform further up over obstacle 40b.

FIG. 4F illustrates the sixth step of the second method for overcoming obstacles. In the sixth step, tracks on the distal end of main frame 2 propel robotic platform 1 backwards over obstacle 40b while operational assembly 3 is tilted over the top of obstacle 40b until the center of gravity of robotic platform 1 is shifted beyond the edge of the obstacle such that the front end of main frame 2 (the end which is far from obstacle 40b) is raised from ground 34b. The distal end continues to propel the platform over obstacle 40b. As robotic platform 1 advances, larger portions of main frame 2 come in contact with the top of obstacle 34b and therefore larger portions of main frame 2 are used to propel robotic platform 1 until main frame 2 completely rests on top of obstacle 40b. When main frame 2 completely rests on obstacle 40b, operational assembly 3 is tilted back into Operational Mode and robotic platform 1 can carry on with its mission.

The two methods described above to overcome obstacles can be chosen by the operator according to the nature of the obstacle to be overcome and according to operational requirements. For example, when facing a staircase, the first method can provide a continuous maneuver to climb up until the top of the staircase. The second method, however, can provide more torque to overcome a relatively large obstacle. In an alternative embodiment, the power source of robotic platform 1 (heavy lithium ion batteries) is located near the front of operational assembly 3. This location of the heavy batteries far from the pivot of operational assembly 3 results in maximum shifting of the center of gravity 41 during tilting of operational assembly 3 and further facilitates overcoming obstacle 40a-b (either by making it easier to shift center of gravity 41 away from obstacle 40a and raise the near [to obstacle 40a] end of robotic platform as illustrated in FIG. 3B-C, or by making it easier shift center of gravity 41 over obstacle 40b in order to raise the far [from obstacle 40b] end of robotic platform 1 as illustrated in FIG. 4F).

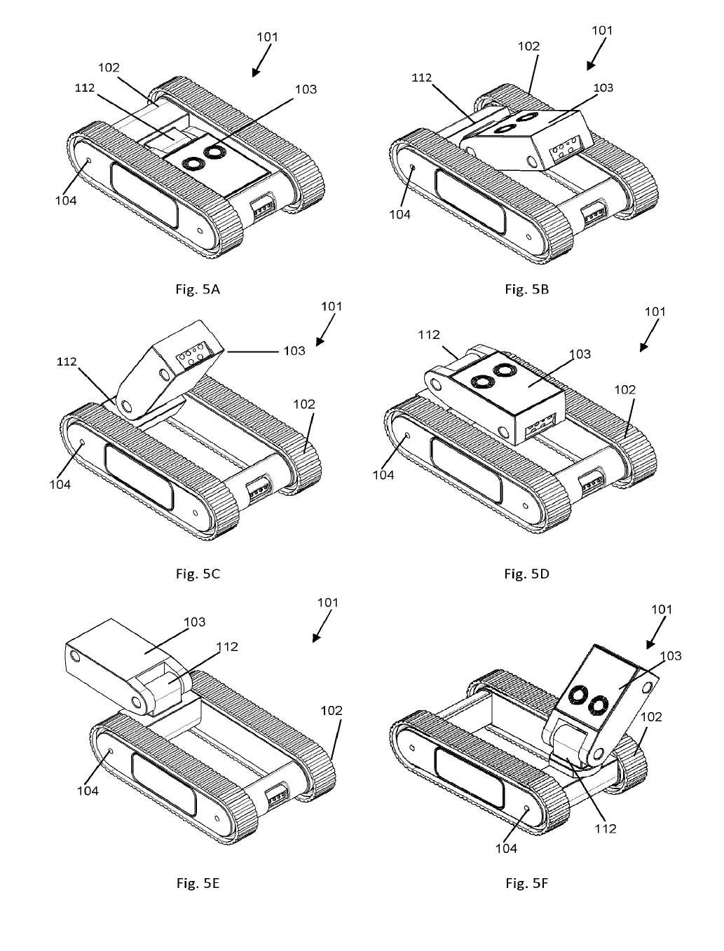

FIGS. 5A, 5B, 5C, 5D, 5E and 5F schematically show a perspective view of a second preferred embodiment of a robotic platform 101 having an articulated operational assembly 103.

Operational assembly 103 is pivotally connected to a main frame 102 by a revolute joint 104 via a universal joint 112. FIG. 5A depicts robotic platform 101 in a Protected Mode as described above with regards to robotic platform 1.

FIG. 5B depicts robotic platform 101 in an Operational Mode as described above with regards to robotic platform 1. Operational assembly 103 is tilted by the revolute joint 104.

FIGS. 5C, 5D, 5E, 5F depict robotic platform 101 in an “Exploring Mode” according to which operational assembly 103 is tilted and traversed according to commands sent by a remote operator in order to investigate regions of interest of the remote operator's choice. FIG. 5C depicts operational assembly 103 highly tilted by revolute joint 104 in order to investigate a region of interest high above robotic platform 101. FIG. 5D illustrates operational assembly 103 held parallel above main frame 102 by revolute joint 104 and universal joint 112 in order to investigate a relatively low region of interest. FIG. 5E depicts operational assembly 103 tilted towards the back of robotic platform 101 by the revolute joint 104 and the universal joint 112. In this preferred embodiment, operational assembly 103 includes a sensor to identify the position operational assembly 103 relative to the ground and to automatically flip the view and the invert commands at the remote operating unit. In this preferred embodiment, revolute joint 104 is turned no more than 90 degrees in order to ensure that the robotic platform does not tip out of balance. FIG. 5F depicts operational assembly 103 held by the universal joint 112 in a reconnaissance mode. Operational assembly 103 is turned all around to see, aim or shoot in any direction without need to reposition main frame 102 by the driving mechanism. In this preferred embodiment, universal joint 112 includes a slip ring mechanism to manage the power supply and the information flow and the communication between operational assembly 103 and main frame 102. Alternatively, operational assembly 103 and main frame 102 may each include its own separable power supplying unit, information gathering means and communication means in order to eliminate the need to incorporate a slip ring mechanism into this preferred embodiment.

Because all of the synchronized components are harnessed within the operational assembly 103, tilting and rotating operational assembly 103 via revolute joint 104 and via universal joint 112 enables imaging, pointing and aiming towards a region of interest or target located anywhere around the operational scene with respect to robotic platform 101 without disrupting the synchronization according to the Three Factor Dynamic Synchronization principle described above.

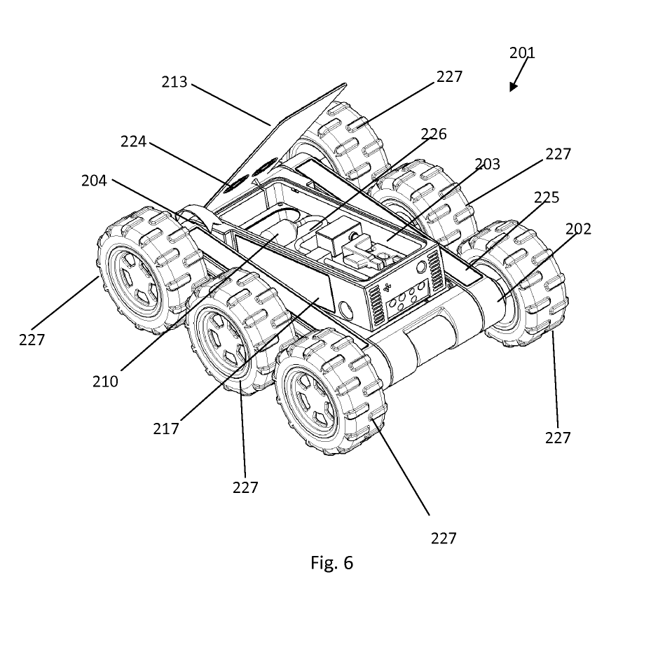

FIG. 6 schematically describes a perspective view of some of the components which are incorporated into another preferred embodiment of a robotic platform 201.

An operational assembly 203 is connected via a revolute joint 204 to the distal end of a main frame 202. Operational assembly 203 includes a detachable cover 213 pivotally connected to operational assembly 203. Detachable cover 213 protects the components inside of operational assembly 203. Detachable cover 213 is opened to enable maintenance of the components inside of operational assembly 203. Detachable cover 213 includes ventilation holes 224 to disperse the heat generated by the different components contained inside operational assembly 203.

In robotic platform 201 a pepper spray mechanism 210 is incorporated into operational assembly 203. Pepper spray mechanism 210 is synchronized with the imaging sensors and the designation sensors according to the Three Factor Dynamic Synchronization principle as detailed in the description of FIG. 1.

In robotic platform 201, side access openings 217 facilitate access to certain components inside the operational assembly 203. Detachable panels 225 on main frame 202 enable rapid swap of lithium ion batteries which supply the power to robotic platform 201.

In robotic platform 201, operational assembly 203 is divided into two separate compartments by a partition 226: the upper compartment includes components which are less sensitive to environmental exposure (e.g., operational means such as a loudspeaker, guns, pepper spray etc.), while the lower compartment (not shown here) stores the components which are more sensitive to environmental exposure, such as detectors, sensors, electrical components etc. Such a design provides another layer of protection to the sensitive components inside operational assembly 203, thus improving their resistance to environmental conditions such as moisture and rain and improves their endurance to varying ground conditions such as mud, puddles etc. This design does not affect the performance of the robotic platform when the platform overturns, thus providing double sided Three Factor Dynamic Synchronization.

In robotic platform 201 the driving mechanism includes six wheels 227a, 227b, 227c, 227d, 227e, 227f incorporated into main frame 202. Each of the central wheels 227b,e includes a spring-based horizontal track offset mechanism to enable independent vertical offset of each of the central wheels 227b,e with respect to the other wheels 227a,c,d,f. Independent vertical offset allows robotic platform 201 distribute the propelling power more efficiently between all 6 wheels 227a,b,c,d,e,f during obstacle climbing. This enhances the mobility of robotic platform 201 by decreasing the angle of the main frame with respect to obstacles being overcome and lowering the center of gravity of robotic platform 201 which minimizes the probability of an inadvertent overturning. Such a mechanism can also include standard shock absorbent additions. For the sake of brevity (there are numerous methods by which driving mechanisms can be incorporated to propel robotic platforms); references made herein are by way of example only. It is to be emphasized that lack of descriptions of other methods by which the robotic platforms can be propelled shall not impose a restriction over the scope of the present invention.

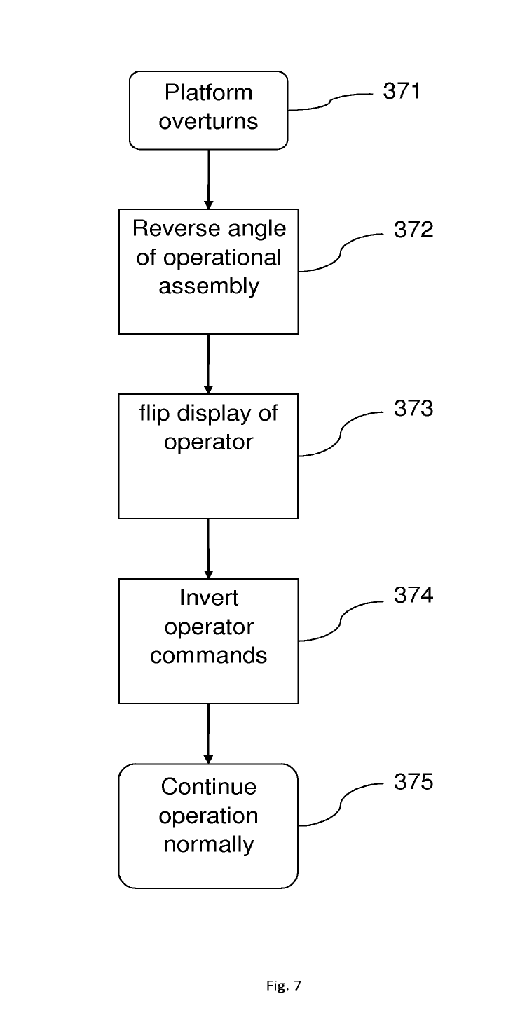

FIG. 7 is a flowchart illustrating a method to operate a bilateral platform after overturning. After robotic platform 1 overturns 371, the tilt of operational assembly 3 with respect to main frame 2 is reversed 372 (returning operational assembly 2 to an uptilted configuration). The display of the operator is also flipped 373 (to give a right side up image) and the operator commands are inverted 374 so that the inverted platform reacts to right-left commands in an intuitive way like the right side up platform. Then operation can continue normally 375. As described above the switching procedure could be performed automatically when an orientation sensor detects an inversion of the robotic platform, or when the operator presses a “turn over” button.

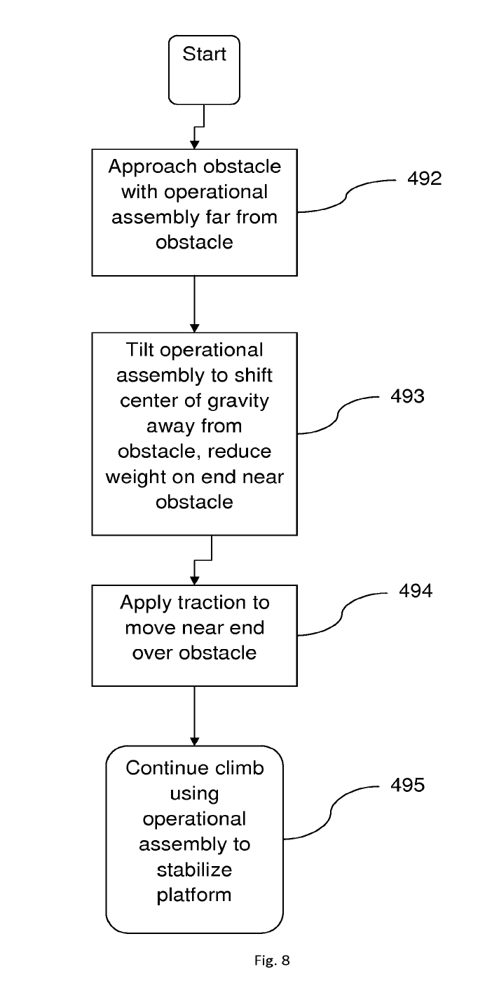

FIG. 8 is a flowchart illustrating a first method to overcome an obstacle. Robotic platform 1 approaches 492 obstacle 40a with the front end near the obstacle and the rear end (to which central assembly 3 is attached) far from obstacle 40a (as illustrated in FIG. 3A-F). Operational assembly 3 is tilted 493 away from obstacle 40a shifting center of gravity 41 away from obstacle 40a and reducing the downward gravitational force on the front of robotic platform 1 which is the end near obstacle 40a. Then traction is applied 494 to move the front end (which is the end near obstacle 40a) over obstacle 40a, and travel up the obstacle continues using operational assembly 3 to stabilize 495 robotic platform 1 while climbing. It should be noted that the method of FIG. 8 could be automated such that the operator may simply face robotic platform 1 toward an obstacle and press a “climb forward” button and robotic platform 1 automatically climbs by the above method.

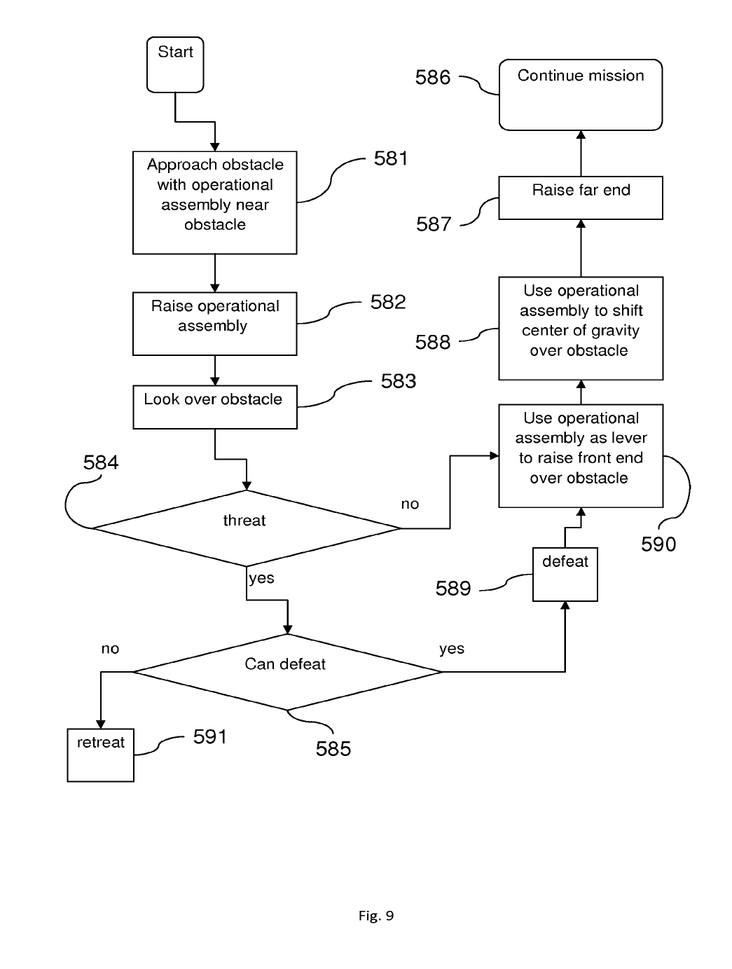

FIG. 9 is a flowchart illustrating a second method to overcome an obstacle (as illustrated in FIGS. 4A-F). Robotic platform 1 approaches 581 obstacle 40b with the rear end (to which central assembly 3 is attached) near the obstacle and the front end far from obstacle 40a. Operational assembly 3 is raised 582 over obstacle 40b until the operator can see 583 over obstacle 40b. If a threat is detected 584 then it is determined 585 if the threat can be defeated. If the threat can not be defeated robotic platform 1 retreats 591. Otherwise, if the threat can be defeated, then robotic platform 1 defeats 589 the threat. After defeating 589 the threat (or in the case where there is no threat) robotic platform 1 uses 590 operational assembly 3 as a lever (either by pushing down against the top of obstacle 40b as illustrated in FIGS. 4D-E or by pushing down against ground 34b) to raise the near end (rear end of robotic platform 1) over obstacle 40b. Then traction and the weight of operational assembly 3 are used to shift 588 the center of gravity of robotic platform 1 over obstacle 40b (as illustrated in FIG. 4F) and raise 587 the far end (far from obstacle 40b which is the front end of robotic platform 1 as illustrated in FIG. 4F). Once over the obstacle the mission continues 586. It should be noted that many of the steps of the method of FIG. 9 could be automated (possibly excluding recognizing and defeating a threat) such that the operator may simply face the back of robotic platform 1 toward an obstacle and press a “overcome obstacle” button and robotic platform 1 automatically climbs by the above method.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1) A robotic platform having a main frame and comprising:
A) a drive mechanism configured for propelling the robotic platform bilaterally;
B) an operational assembly configured for adjustably tilting with respect to the main frame, and
C) a sensor mounted to said operational assembly, said sensor configured for orientation the robotic platform, and wherein said operational assembly is configured for raising said sensor above said main frame.

2) The robotic platform of claim 1, wherein said tilting is to a non-zero angle with respect to the main frame when the robotic platform is in a first vertical orientation and said operational assembly is configured for reversing tilting to an angle opposite to said non-zero angle with respect to the main frame when the robotic platform is inverted from said first vertical orientation.

3) The robotic platform of claim 2, wherein said non-zero angle is an angle between 10 and 60 degrees.

4) The robotic platform of claim 3, further comprising:
D) an image analysis algorithm and wherein said robotic platform is configured to adjust said non zero angle based on an output of said image analysis algorithm.

5) The robotic platform of claim 2, wherein said tilting at said non-zero angle raises said sensor above said main frame.

6) The robotic platform of claim 5, wherein said operational assembly is configured for the majority of the volume of said operational assembly to be located within said main frame when tilting of said operational assembly is at said non-zero angle.

7) The robotic platform of claim 5, wherein said operational assembly is configured for the majority of the volume of said operational assembly to be surrounded on four sides by said main frame when said operational assembly is at said non-zero angle.

8) The robotic platform of claim 1, wherein said operational assembly is configured to fit entirely within said main frame when the robotic platform is in a protected mode.

9) The robotic platform of claim 8, further comprising
D) a window in a front panel of said main frame, and said operational assembly may be configured for directing said sensor through said window when said robotic platform is in a protected mode.

10) The robotic platform of claim 8, wherein said tilting is to an angle of zero degrees when said robotic platform is in said protected mode.

11) The robotic platform of claim 1 or 8, wherein one end of said main frame is joined by a revolute joint.

12) The robotic platform of claim 1, wherein said operational assembly is configured for facilitating traversing an obstacle by the robotic platform.

13) The robotic platform of claim 12, wherein said facilitating is by shifting the center of gravity of the robotic platform away from a said obstacle thereby assisting in raising of a near end of the robotic platform over said obstacle.

14) The robotic platform of claim 12, wherein said facilitating is by shifting the center of gravity of the robotic platform in a direction of desired motion and over said obstacle thereby assisting in raising a far end of the robotic platform.

15) The robotic platform of claim 13 or 14, wherein a power supply of said robotic platform is mounted to said operational assembly and moving said operational assembly moves said power supply thereby moving the center of mass of said robotic platform.

16) The robotic platform of claim 1, wherein said raising of said sensor above the main frame is during said propelling.

17) The robotic platform of claim 1, further comprising:
D) a designator, and wherein said designator is mounted to said operational assembly.

18) The robotic platform of claim 17, wherein said designator includes at least one device selected from the group containing a laser, an overlay target mark inscribed to said sensor, an electronically produced target mark and a sight.

19) The robotic platform of claim 17, wherein said designator is synchronized with said sensor.

20) The robotic platform of claim 17, wherein said designator is directed along an axis of said operational assembly.

21) The robotic platform of claim 1, wherein said sensor is directed along an axis of said operational assembly.

22) The robotic platform of claim 1, wherein said operational assembly is configured to raise said sensor over an obstacle.

23) The robotic platform of claim 1, wherein said operational assembly is configured to pivot.

24) The robotic platform of claim 1, further comprising:
D) a weapon, and wherein said weapon is mounted to said operational assembly.

25) The robotic platform of claim 24, wherein said weapon is synchronized with said sensor.

26) The robotic platform of claim 24, wherein said weapon is directed along an axis of said operational assembly.

27) The robotic platform of claim 24, wherein said weapon includes at least one device selected from the group containing a loudspeaker, a barrel based weapon, an electric shocking based weapon, a spray based weapon, a directional acoustic based weapon and a dazzling based weapon.

28) The robotic platform of claim 1, wherein said sensor includes at least one device selected from the group containing an imaging sensor, a light source, a microphone, a light detector, a noise detector, a volume detector, a nuclear detector, a biological detector, a chemical (NBC) detector and a range detector.

29) The robotic platform of claim 1, wherein said sensor is configured to provide stereoscopic vision capabilities.

30) The robotic platform of claim 1, wherein said central assembly is divided into compartments.

31) The robotic platform of claim 1, wherein said propulsion mechanism includes at least one device selected from the group containing wheels, tracks, sliding fins and a sub propelling mechanism.

32) The robotic platform of claim 1, wherein said operational assembly is articulated.

33) The robotic platform of claim 1, wherein said operational assembly is at least partially covered by a solar panel.

34) The robotic platform of claim 1, wherein a control signal is reversed when said robotic platform is inverted.

35) The robotic platform of claim 1, wherein an operator display image is flipped by 180 degrees when said robotic platform is inverted.

36) A method of overcoming an obstacle with a robotic platform comprising:
A) approaching the obstacle, and
B) shifting the center of gravity of the robotic platform away from the obstacle in order to facilitate raising a near end of the robotic platform.

36) A method of overcoming an obstacle with a robotic platform comprising:
A) raising a near end of the robotic platform over the obstacle, and
B) shifting the center of gravity of the robotic platform in the direction of travel thereby facilitating raising of a far end of the robotic platform.
